(19) United States
(12) Patent Application Publication
(10) Pub. No.: US 2016/0189204 A1
(43) Pub. Date: Jun. 30, 2016

(54) SYSTEMS AND METHODS FOR BUILDING KEYWORD SEARCHABLE AUDIENCE BASED ON PERFORMANCE RANKING

(71) Applicant: Yahoo! Inc., Sunnyvale, CA (US)

(72) Inventors: Lin MA, Sunnyvale, CA (US); Rohit BHATIA, Sunnyvale, CA (US); Xiao HAN, Beijing (CN)

(73) Assignee: Yahoo! Inc., Sunnyvale, CA (US)

(21) Appl. No.: 14/587,282

(22) Filed: Dec. 31, 2014

Related U.S. Application Data
(63) Continuation of application No. PCT/CN2014/095607, filed on Dec. 30, 2014.

(51) Int. Cl. G06Q 30/02

(52) U.S. Cl. CPC G06Q 30/0244; G06Q 30/0201; G06Q 30/0205

(57) ABSTRACT

Systems and methods for building keyword searchable audience based on performance ranking are provided. The system includes a processor and a non-transitory storage medium accessible to the processor. The system includes a memory storing a database comprising segment data and campaign data. A computer server is in communication with the memory and the database, the computer server programmed to: obtain a performance-lift vector for an audience segment; obtain a campaign vector using meta-data from the campaign data; obtain a keyword vector for the audience segment using the performance-lift vector and the campaign vector; receive an input from a user interface accessible to an advertiser; and search the segment data at least partially based on the input and the keyword vector for segments in the segment data.

### CROSS-REFERENCE TO RELATED APPLICATIONS

This application is a continuation of International Application No. PCT/CN2014/095607, filed on Dec. 30, 2014, which is hereby incorporated herein by reference in its entirety.

### BACKGROUND

The Internet is a ubiquitous medium of communication in most parts of the world. The emergence of the Internet has opened a new forum for the creation and placement of advertisements (ads) promoting products, services, and brands. Internet content providers rely on advertising revenue to drive the production of free or low cost content. Advertisers, in turn, increasingly view Internet content portals and online publications as a critically important medium for the placement of advertisements.

In online marketing and online advertising, a target audience is a specific group of people within the target market at which a product or the marketing message of a product is aimed. For example, if a company sells new sports shoes for boys (target market) the online advertising may be aimed at the parents (target audience) who take care of shopping for their kids. Generally, a target audience may be selected based on factors including: age group, gender, marital status, etc. Thus, the online advertisements service providers may have built and stored data about thousands of audience segments: e.g. female teenagers in Illinois, single people in Chicago, etc. As the number of target audiences increases, it is difficult to manage or understand by a human. As a result, only a small number of audience segments are used widely by advertisers.

Therefore, the existing online advertisement systems are not efficient for advertisers to identify audience segments meeting their needs. In short, the existing technology does not provide an efficient solution to the advertisers on how to search target audience segments from the database. Thus, there is a need to develop methods and systems to help advertisers to quickly identify audience segments and quantify estimated performances of the audience segments.

### SUMMARY

Different from conventional solutions, the disclosed system solves the above problem by building keyword searchable audience segments based on performance ranking.

In a first aspect, the embodiments disclose a computer system that includes a processor and a non-transitory storage medium accessible to the processor. The system also includes a memory storing a database comprising segment data and campaign data. A computer server is in communication with the memory and the database, the computer server programmed to: obtain a performance-lift vector for an audience segment; obtain a campaign vector using meta-data from the campaign data; obtain a keyword vector for the audience segment using the performance-lift vector and the campaign vector; receive an input from a user interface accessible to an advertiser; and search the segment data at least partially based on the input and the keyword vector for segments in the segment data.

In a second aspect, the embodiments disclose a computer implemented method by a system that includes one or more devices having a processor. In the computer implemented method, the system obtains segment data and campaign data from a memory storing a database. The system obtains a performance-lift vector for an audience segment, where the performance-lift vector includes a difference of a performance of the audience segment for a campaign and an average performance of other audience segments for the campaign. The system obtains a campaign vector using meta-data from the campaign data. The system obtains a keyword vector for the audience segment using the performance-lift vector and the campaign vector. The system searches the segment data at least partially based on an input and the keyword vector for segments in the segment data.

In a third aspect, the embodiments disclose a non-transitory storage medium configured to store a set of modules. The non-transitory storage medium includes a module for obtaining a performance-lift vector for an audience segment, where the performance-lift vector includes a difference of a performance of the audience segment for a campaign and an average performance of other audience segments for the campaign. The non-transitory storage medium further includes a module for obtaining a campaign vector using meta-data from a database comprising campaign data. The non-transitory storage medium further includes a module for obtaining a keyword vector for the audience segment using the performance-lift vector and the campaign vector. The non-transitory storage medium further includes a module for displaying a user interface and receiving an input from the user interface accessible to an advertiser. The non-transitory storage medium further includes a module for searching a database including segment data at least partially based on an input and the keyword vector for segments in the segment data.

In a fourth aspect, the embodiments disclose a computer system that includes a backend computer server in communication with a database. The backend computer server programmed to: obtain a performance-lift vector for an audience segment, obtain a keyword vector for the audience segment at least partially based on the performance-lift vector, and save the keyword vector in the database. The system also includes a frontend computer server in communication with the database, where the frontend computer server is programmed to: receive an input from a user interface and search the database at least partially based on the input and the keyword vector.

### BRIEF DESCRIPTION OF THE DRAWINGS

FIG. 1 is a block diagram of an example environment in which a computer system according to embodiments of the disclosure may operate;

FIG. 2 illustrates an example computing device in the computer system;

FIG. 3 illustrates an example embodiment of a server computer for building a keyword index for an audience segment;

FIG. 4 is an example block diagram illustrating embodiments of the non-transitory storage of the server computer;

FIG. 5 is an example flow diagram illustrating embodiments of the disclosure;

FIG. 6 is an example flow diagram illustrating embodiments of the disclosure; and

FIG. 7 is an example user interface illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

While the publisher and social networks collect more and more user data through different types of e-commerce applications, news applications, games, social networks applications, and other mobile applications on different mobile devices, a user may by tagged with different features accordingly. Using these different tagged features, online advertising providers may create more and more audience segments to meet the different targeting goals of different advertisers. Thus, it is desirable for advertisers to directly select the audience segments with the best performances using keywords. Further, it would be desirable to the online advertising providers to provide more efficient services to the advertisers so that the advertisers can select the audience segments without reading through the different features or descriptions of the audience segments. The present disclosure provides a computer system that uses keyword vectors to represent an audience segment and provides intuitive user interfaces to allow advertisers to use keywords to search for any audience segments.

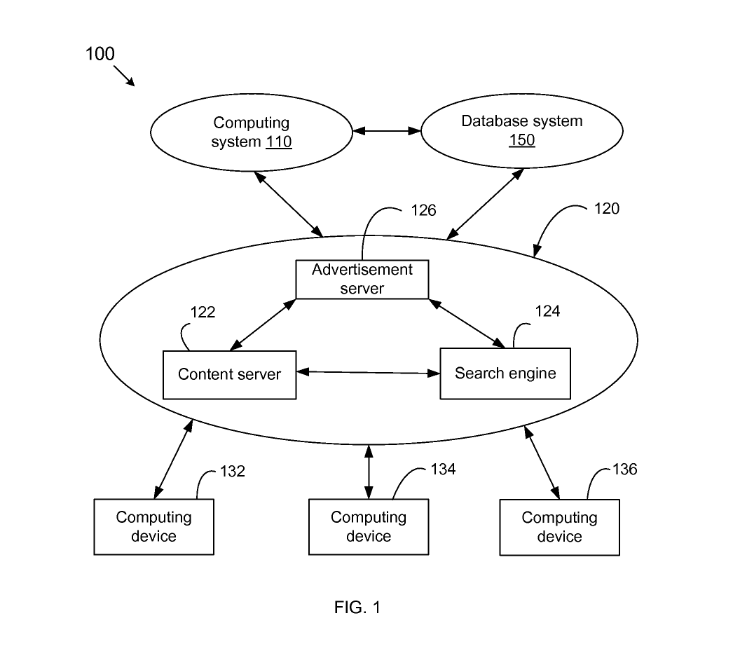

FIG. 1 is a block diagram of an environment 100 in which a computer system according to embodiments of the disclosure may operate. However, it should be appreciated that the systems and methods described below are not limited to use with the particular exemplary environment 100 shown in FIG. 1 but may be extended to a wide variety of implementations.

The environment 100 may include a computing system 110 and a connected server system 120 including a content server 122, a search engine 124, and an advertisement server 126. The computing system 110 may include a cloud computing environment or other computer servers. The server system 120 may include additional servers for additional computing or service purposes. For example, the server system 120 may include servers for social networks, online shopping sites, and any other online services.

The computing system 110 may include a backend computer server. The backend computer server is in communication with the database system 150. The backend computer server is programmed to obtain a performance-lift vector for an audience segment, obtain a keyword vector for the audience segment at least partially based on the performance-lift vector, and save the keyword vector in the database 150. The backend computer server is further programmed to: obtain a campaign vector that comprises a sub-vector of keywords and a sub-vector of weighs corresponding to the sub-vector of keywords, and the sub-vector of keywords comprises keywords at least partially related to creative landing uniform resource locator (URL), advertiser name, and product name. The backend computer server is programmed to obtain and update the performance-lift vector, the campaign vector, and the keyword vector periodically in an offline training process. The backend computer server is programmed to obtain the sub-vector of weights corresponding to the sub-vector of keywords using a process based on a term frequency-inverse document frequency (TF-IDF) of the keywords in the sub-vector of keywords.

The server system 120 may include a frontend computer server implemented in the advertisement serer. The frontend computer server is in communication with the database system 150. The frontend computer server is programmed to receive an input from a user interface and search the database at least partially based on the input and the keyword vector. The frontend computer server is programmed to obtain an input vector using the input, the input vector indicating at least one of: a geographical feature, a demographical feature, a mobile application feature, a technology feature, and a publisher feature; select an audience segment using a dot product of the input vector and the keyword vector in real time; and display information indicating the selected audience to an advertiser.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more computer servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser. The advertisement server 126 may include computer servers for providing ads to different platforms and websites.

The computing system 110 and the connected server system 120 have access to a database system 150. The database system 150 may include memory such as disk memory or semiconductor memory to implement one or more databases. At least one of the databases in the database system may be a user database that stores information related to a plurality of users. The user database may be organized on a user-by-user basis such that each user has a unique record file. The record file may include all information related to a specific user from all data sources. For example, the record file may include personal information of the user, search histories of the user from the search engine 124, web browsing histories of the user from the content server 122, or any other information the user agreed to share with a service provider that is affiliated with the computer server system 120.

The environment 100 may further include a plurality of computing devices 132, 134, and 136. The computing devices may be a computer, a smart phone, a personal digital aid, a digital reader, a Global Positioning System (GPS) receiver, or any other device that may be used to access the Internet.

The disclosed system and method for building keyword searchable audience segments may be implemented by the computing system 110. Alternatively or additionally, the system and method for building keyword searchable audience segments may be implemented by one or more of the servers in the server system 120. The disclosed system may instruct the computing devices 132, 134, and 136 to display all or part of the user interfaces to request input from the advertisers. The disclosed system may also instruct the computing devices 132, 134, and 136 to display all or part of the brand performance to the advertisers.

Generally, an advertiser or any other user may use a computing device such as computing devices 132, 134, and 136 to access information on the server system 120 and the data in the database 150. The advertiser may want to identify a target audience for the advertiser's product or services. Based on the target audience and the products, the advertiser may start one or more online advertising campaigns on different online platforms. One of the technical problems solved by the disclosure is a lack of efficiency in setting up an online advertising campaign. Conventional campaign setup requires substantial computer resources and time for locating and selecting desired audience segments. The disclosed solution increases the efficiency of online campaign setup so that an advertiser can use intuitive keywords to search all audience segments and identify the desired audience segments in real time.

Further, the system solves technical problems presented by managing large amounts of user data represented by different user features collected by all types of mobile applications. Through processing collected data, the systems index audience segments by keywords, so that the audience segments are searchable by keywords. The keyword index is indicative of the performance of the underlying audience segment. The keyword index has both semantic and performance meanings. Use of the keyword index provides a rapid and clear understanding of the expected performance for an audience segment. The keyword index may be tracked and understood by the advertisers or machines accessible to the advertisers.

The system further enables the data providers to save their efforts to name, document, train, or tag their segments in order to let each advertiser to be aware what the segment is for. With the keyword index, a data provider can easily quantify an audience segment using a keyword vector.

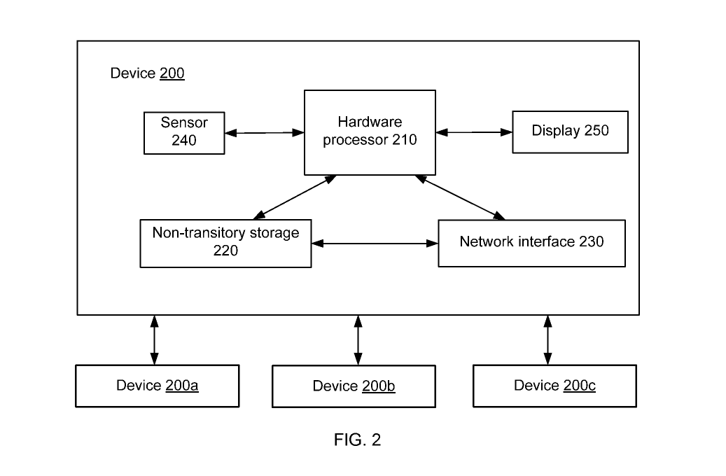

FIG. 2 illustrates an example computing device 200 for interacting with the advertiser. The computing device 200 may communicate with a frontend computer server of the system. The computing device 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

The computing device 200 may display user interfaces on a display unit 250. For example, the computing device 200 may display a user interface on the display unit 250 asking the advertiser to input one or more keywords. The user interface may provide checkboxes, dropdown selections or other types of graphical user interfaces for the advertiser to select geographical information, demographical information, mobile application information, technology information, publisher information, or other information related to features of an audience segment.

The computing device 200 may further display the predicted performance using one or more audience segments. The computing device 200 may also display one or more drawings or figures that have different formats such as bar charts, pie charts, trend lines, area charts, etc. The drawings and figures may represent the audience segments and/or the performance of the audience segments.

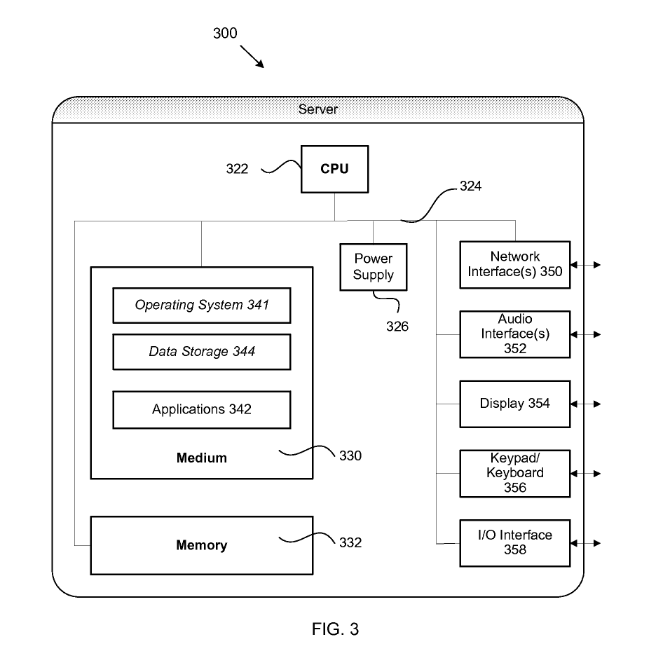

FIG. 3 is a schematic diagram illustrating an example embodiment of a server. A server 300 may include different hardware configurations or capabilities. For example, a server 300 may include one or more central processing units 322, memory 332 that is accessible to the one or more central processing units 322, one or more medium 630 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as any computer server shown in FIG. 1. The server 300 may also serve as a computer server that implements the computer system for building keyword searchable audience segments. In either case, the server 300 is in communication with a database that stores segment data and campaign data. The segment data may include different audience segments built on search data, email data, page view data, TV data, mobile application data, social data, and etc. collected by different data providers. The campaign data may include creative landing uniform resource locator (URL), advertiser name, advertiser product, competitor information, campaign slogan, or other meta-data related to a campaign.

For example, the segment data may include at least the following data related to the underlying product or service: the age group of the audience, the income range of the audience, the geographical location of main residence, the spending range in a preset time period, the TV provider of the audience, and the number of friends in one or more social networks. These aspects may represent campaign features collected from search data, content data, email data, and social areas. The campaign data may include both history campaign data and campaign data of currently running campaigns. The segment data may also be updated periodically based on newly collected data on currently running campaigns.

The server 300 builds a keyword vector to represent an audience segment. The keyword vector indicates that the audience segment has good performance in campaigns which is represented by such keywords. The good performance may include two meanings. First, compared with other audience segments, the audience segment has higher performance metrics. Second, compared with other campaigns, the audience segment performs better in one specific campaign. For example, if an audience segment always performs better in campaigns related to campaign topics about “recreational vehicle (RV),” then the terms “recreational vehicle” and/or “RV” should be included in the keyword vector of the audience segment. Thus, the server 300 gives a keyword vector the meaning of both semantics relevance by including the relevant campaign topics and performance meanings by considering the lift of performance in such relevant campaigns. The lift of performance may be a performance increase in terms of a performance metric pre-selected by advertisers.

Specifically, the server 300 may be programmed to obtain a performance-lift vector for an audience segment. The performance-lift vector may include a difference of a performance of the audience segment for a campaign and an average performance of other audience segments for the campaign. The server 300 may be programmed to obtain a campaign vector using meta-data from the campaign data. The server 300 may be programmed to obtain a keyword vector for the audience segment using the performance-lift vector and the campaign vector. The server 300 may be programmed to receive an input from a user interface accessible to an advertiser. The server 300 may be programmed to search the segment data at least partially based on the input and the keyword vector for segments in the segment data. The server 300 may be programmed to implement part of the above acts in a non-real-time mode, which may include offline computations. The server 300 may implement part of the above acts in a real time mode, which may be accomplished in a preset short period of time, for example, less than a few seconds or even less than a few milliseconds.

The audience segment may include a plurality of audience features that includes at least one of: a geographical feature of the audience segment, a demographical feature of the audience segment, a mobile application related to the audience segment, a technology related to the audience segment, and a publisher related to the audience segment. The number of different audience features may be very large, for example, thousands. For a specific audience segment, there may be only one hundred active features or less. In some instances, the number of active features for an audience segment may be around 10 to 30. Thus, the audience segment may be represented using a sparse matrix.

Similarly, a campaign vector may include a sub-vector of keywords and a sub-vector of weighs corresponding to the sub-vector of keywords. The sub-vector of keywords may include keywords at least partially related to creative landing uniform resource locator (URL), advertiser name, and product name.

The server 300 is programmed to obtain an input from a user interface on a terminal device. The user interface may include a plurality of user input fields at least partially related to categories of the plurality of audience features. For example, the user interface may request the advertiser to describe the target audience using an input that indicates at least one of: a geographical feature, a demographical feature, a mobile application feature, a technology feature, and a publisher feature of the target audience. The user interface may provide a dropdown menu or a blank field for an advertiser to select or describe the features.

After obtaining the input from the advertiser, the server 300 is programmed to obtain an input vector using the input, where the input vector indicates at least one of: a geographical feature, a demographical feature, a mobile application feature, a technology feature, and a publisher feature, or any other suitable, convenient or desired feature, or feature of interest to an advertiser. The server 300 may calculate a dot product of the input vector and the keyword vector of an audience group. The server 300 may then select and recommend an audience segment to the advertiser using the dot product of the input vector and the keyword vector. For example, the server 300 may select audience segments that have the highest values of dot products. The server 300 is programmed to select audience segment with a dot product greater than a preset threshold value. Alternatively or additionally, the server 300 may sort a plurality of pre-selected audience segments using the dot products and then display the top audience segments. The advertiser may further refine the top audience segments manually.

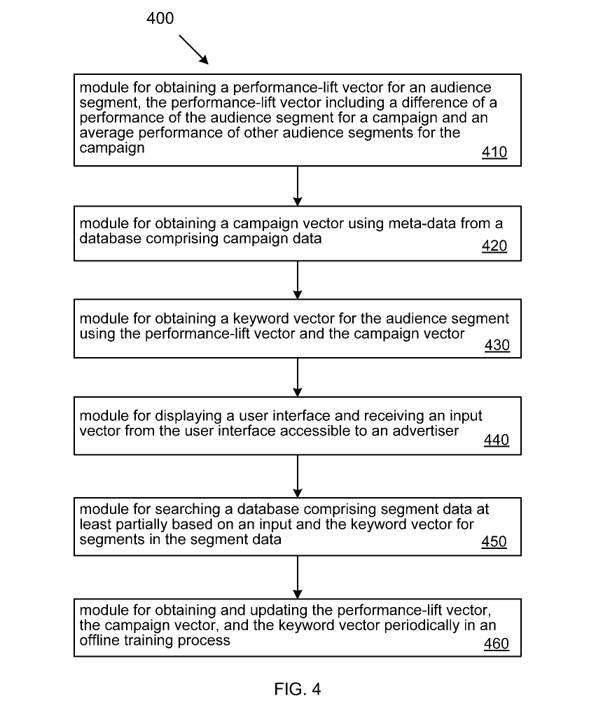

FIG. 4 illustrates embodiments of a non-transitory storage medium 400 in the server 300 illustrated in FIG. 3. The non-transitory storage medium 400 includes one or more modules. The one or more modules may be implemented as program code and data stored on the non-transitory storage medium, for example. The non-transitory storage medium 400 may include alternative, additional or fewer modules in other embodiments. The non-transitory storage medium 400 includes a module for recording data in a database.

The non-transitory storage medium 400 includes a module 410 for obtaining a performance-lift vector for an audience segment, where the performance-lift vector includes a difference of a performance of the audience segment for a campaign and an average performance of other audience segments for the campaign.

The non-transitory storage medium 400 includes a module 420 for obtaining a campaign vector using meta-data from a database including campaign data. The campaign data may include history campaign data and updates from currently running campaigns. The campaign vector may include pairs of keyword and its corresponding weight. For example, a vector H=(sports: 100, super bowl: 80, 49er: 75), which means the vector includes three keywords (or tokens) “sports”, “super bowl,” and “49er”, and their respective weights are 100, 80, and 75. Other arrangements or configurations of the vector may be used, for example to achieve more efficient data processing, to reduce the amount of memory used, etc.

The non-transitory storage medium 400 includes a module 430 for obtaining a keyword vector for the audience segment using the performance-lift vector and the campaign vector. For example, the keyword vector for an audience segment may be calculated using the sum of a plurality of terms, where each term equals a product of a performance-lift vector of a specific campaign and the campaign vector of the specific campaign.

The non-transitory storage medium 400 includes a module 440 for displaying a user interface and receiving an input from the user interface accessible to an advertiser. The user interface may be displayed at least partially on a user terminal device accessible to an advertiser.

The non-transitory storage medium 400 may further include a module 450 for searching a database comprising segment data at least partially based on an input and the keyword vector for segments in the segment data. For instance, a frontend computer server may quantify the input using an input vector at least partially based on historical data related to the input. The non-transitory storage medium 400 may further include a module for selecting an audience segment using a dot product of an input vector and the keyword vector, where the input vector is at least partially related to the input from an advertiser.

The non-transitory storage medium 400 may further include a module 460 for obtaining and updating the performance-lift vector, the campaign vector, and the keyword vector periodically in an offline training process. The offline training process may be implemented at least partially in a backend computer server. The time period between each update may be preset by the computer system or individually selected by an advertiser.

The non-transitory storage medium 400 may include a displaying module for displaying the selected audience segment in the user interface. The displaying module may display aggregate estimates of all selected audiences. The estimates may include: the total amount of budget in a tie period, the estimated number of clicks, or other performance estimates. The modules for displaying may further include sub-modules to adjust the display effects on different hardware devices.

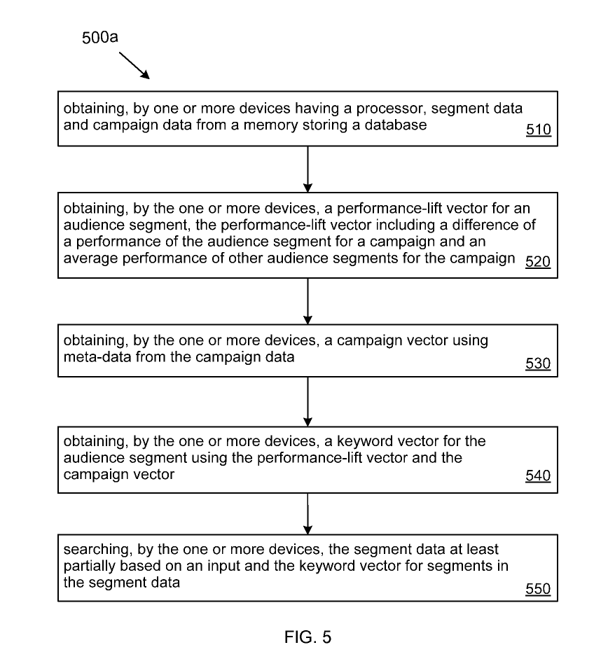

FIG. 5 is an example flow diagram 500a illustrating embodiments of the disclosure. The flow diagram 500a may be implemented at least partially by a computer system that includes a computer server 300 having a processor or computer and illustrated in FIG. 3. The computer implemented method according to the example block diagram 500a includes the following acts. Other acts may be added or substituted.

In act 510, the computer system obtains segment data and campaign data from a memory storing a database. For example, the computer system may obtain segment data and campaign data in a particular geographical region during a certain period of time. The advertiser may determine which region they are interested and how much history data should be used for a specific advertising campaign.

In act 520, the computer system obtains a performance-lift vector for an audience segment. The performance-lift vector may include a difference of a performance of the audience segment for a campaign and an average performance of other audience segments for the campaign. The average performance of other audience segments may represent customers that generally click a link even without any exposure to an advertisement. These customers may include existing loyal customers and customers with predetermined shopping decisions to buy the underlying product or service.

For example, each audience segment may be measured by lift of performance in terms of click through rate (CTR) or conversion rate (CVR) on each campaign. Here, the CTR is a way of measuring the success of an online advertising campaign for a particular website as well as the effectiveness of an email campaign by the number of users that clicked on a specific link. For example, the CTR may be calculated as the number of times a click is made on the advertisement divided by the total impressions (the number of times an advertisement was served). The particular website and the specific link may be specified by the advertiser in advance. The CVR is the proportion of visits to a website who take action to go beyond a casual content view or website visit, as a result of subtle or direct requests from marketers, advertisers, and content creators. Successful conversions may be defined differently by individual marketers, advertisers, and content creators. For instance, a successful conversion to an online retailer may be defined as the sale of a product to a consumer whose interest in the item was initially sparked by clicking a banner advertisement. A successful conversion to a content provider may refer to a membership registration, newsletter subscription, software download, or other activity. Other types of performance may be used as well. The performance-lift vector for a segment may be calculated at least partially based on the following equation.

Segmentᵢ=(Liftᵢ¹,Liftᵢ¹, . . . , Liftᵢ^{j}, . . . , Liftᵢ^{N})

where the Liftᵢ^{j} represents the lift of segmentᵢ in campaignⱼ. The vector indicates, for each campaign, what is the performance lift of the segment.

In a cost per click (CPC) campaign, the vector element may be calculated at least partially based on the following equation.

Liftᵢ^{j}=(clickᵢ^{j}/impressionᵢ^{j}−click^{j}/impression^{j})/(click^{j}/impression^{j}).

In a cost per action (CPA) campaign, the vector element may be calculated at least partially based on the following equation.

Liftᵢ^{j}=(conversionᵢ^{j}/impressionᵢ^{j}−conversion^{j}/impression^{j})/(conversion^{j}/impression^{j})

In both types of campaigns, the terms clickᵢ^{j} and impressionᵢ^{j} respectively represent the click and impression count of segmentᵢ under campaignⱼ, the click^{j} and impression^{j} respectively represent the click and impression count of campaignⱼ.

In act 530, the computer system obtains a campaign vector using meta-data from the campaign data. For example, a specific campaign may be represented by the following campaign vector,

Campaign i=(KW1:Weight1, KW2:Weight2, . . . KWj:Weight j, . . . KWn:Weight n)

where KW1, KW2, . . . KWn indicate different keywords, Weight1, Weight2, . . . Weightn indicate the corresponding weights of the corresponding keywords. The campaign vector may be stored in a hash table-like data structure. For example, a campaign vector C (KW1:200, KW2: 180, KW3: 70) indicates that the campaign vector include three tokens: KW1, KW2 and KW3, and their respective weights: 200, 180 and 70. The tokens may be stored as hash table keys which may be mapped to the respective weights. The hash table-like structure makes it very convenient to add new tokens, which may be added as a new entry into the hash table.

In act 540, the computer system obtains a keyword vector for the audience segment using the performance-lift vector and the campaign vector. For example, the keyword vector for audience segment ABC may be calculated at least partially based on the following equation.

Segment(ABC)=Σᵢ Lift_{ABC}ⁱ*Campaign i

where the Lift_{ABC}ⁱ is the performance lift of segment_{ABC} in campaignᵢ introduced in act 520, and Campaignᵢ is the campaign semantic vector as introduced in act 530.

The segment may be represented by a keyword vector in the following format.

Segment(ABC)=(SKW1:SWeight1,SKW2:SWeight2, . . . SKWj:SWeight j, . . . SKWn:SWeight n)

where SKW1, SKW2, . . . SKWn indicate different segment keywords, SWeight1, SWeight2, . . . SWeightn indicate the corresponding weights of the corresponding segment keywords. Similarly, the keyword vectors for audience segments may be stored in a hash table-like data structure. The acts 510-540 may be performed by a backend computer server. These acts may be performed in an offline training process in the backend computer server. The backend computer server may generally do not direct interact with advertisers.

In act 550, the computer system searches the segment data at least partially based on an input and the keyword vector for segments in the segment data. For example, the computer system may obtain dot products between the input vector and each keyword vector in the segment data. A greater value of dot product indicates that the underlying audience segment is highly related to the advertiser input and also is highly likely to have greater performance than audience segments with a lower value of dot product. The computer system may then select the audience segments at least partially using the dot products.

Both the input vector and keyword vector for segments may be stored based on hash table-like data structure. Supposing the input vector from the advertiser is H1 (sports:100, super bowl: 80, 49er: 75) and the keyword vector for an audience segment is H2 (sports: 60, baseball: 95, Giants: 90), the similarity between H1 and H2 may be easily calculated by multiple weights of common keywords (tokens) in both vectors. In this case, the dot product between H1 and H2 is 100*60 (for common sports token). The computer server may use hash tables to quickly determine whether a token exists in a specific hash table and quickly fetch its weight. The computer server may perform the dot products between vectors in real time with the vectors stored using hash table data structure.

The act 550 may be performed by a frontend computer server. The frontend computer server may direct interact with advertisers.

The above acts may be repeated to get more conversions. For example, the acts may be repeated for each day or each week to update the allocation of the budget during each day or each week.

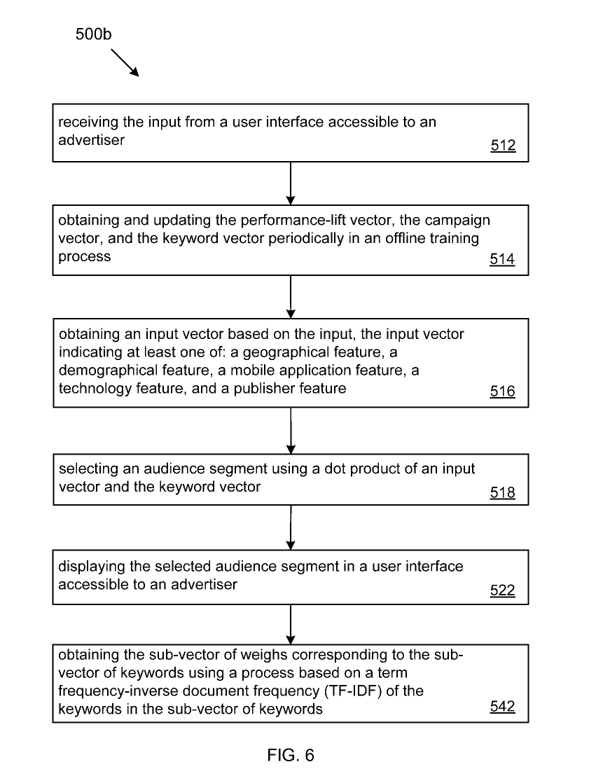

FIG. 6 is an example flow diagram 500b illustrating embodiments of the disclosure. The acts in the example flow diagram 500b may be combined with the acts in the flow diagram 500a shown in FIG. 5. Similarly, the acts in flow diagram 500b may be implemented at least partially by a computer system that includes a server computer 300 disclosed in FIG. 3. The computer implemented method according to the example flow diagram 500b includes the following acts. Other acts may be added or substituted.

In act 512, the computer system receives the input from a user interface accessible to an advertiser. This act may be performed by a frontend computer server or a terminal device that directly communicate with the frontend computer server.

In act 514, the computer system obtains and updates the performance-lift vector, the campaign vector, and the keyword vector periodically in an offline training process. In some embodiments, this act may be included in act 520 in FIG. 5. For example, the backend computer server may update the performance-lift vectors every two days. Similarly, the backend computer server may update the campaign vector and the keyword vector every week or every two days. The time period between consecutive updates may be adjusted manually by advertisers or automatically by the backend computer server.

In act 516, the computer system obtains an input vector using the input, the input vector indicating at least one of: a geographical feature, a demographical feature, a mobile application feature, a technology feature, and a publisher feature. In other embodiments, the input vector may indicate any other convenient or desirable feature. This act may be included in act 510 in FIG. 5A.

In act 518, the computer system selects an audience segment using a dot product of an input vector and the keyword vector. This act may be implemented by a frontend computer server. One way to implement the dot product is to use sparse matrix stored using hash tables as described above. Other ways to implement dot products may be used as well. This act may be included in act 550 in FIG. 5.

In act 522, the computer system displays the selected audience segment in a user interface accessible to an advertiser. The frontend computer server may send information indicative of the selected audience segment to a terminal device accessible by the advertiser. The frontend computer server may instruct the terminal device to display the selected audience segment according to advertiser preferences.

In act 542, the computer system obtains the sub-vector of weighs corresponding to the sub-vector of keywords using a process based on a term frequency-inverse document frequency (TF-IDF) of the keywords in the sub-vector of keywords. The TF-IDF is a numerical statistic that reflects at least partially how important a word is to a document in a collection or corpus. The TF-IDF may be used as a weighting factor in information retrieval and text mining. The TF-IDF value increases proportionally to the number of times a word appears in the document, but is offset by the frequency of the word in the corpus, which helps to adjust for the fact that some words appear more frequently in general. Other types of similar statistic may be adopted to calculate the weights as well.

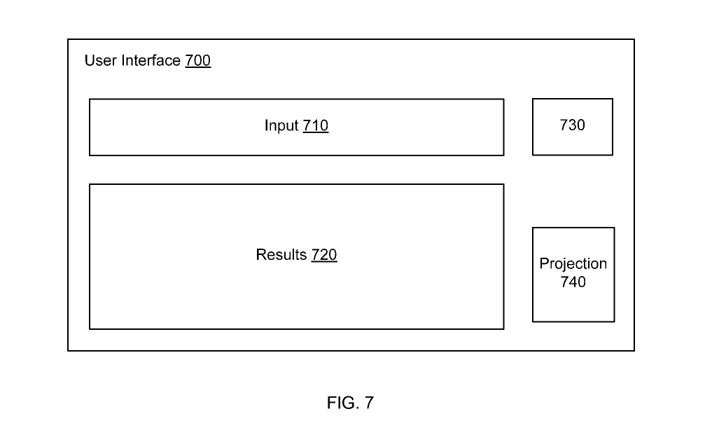

FIG. 7 is an exemplary user interface 700 illustrating embodiments of the disclosure. The user interface 700 may be displayed by a frontend computer server or a terminal device in direct communication with the frontend computer server. The user interface 700 includes an input field 710 that an advertiser may input keywords to describe features of the target audiences. The input may include a geographical feature, a demographical feature, a mobile application feature, a technology feature, and a publisher feature of the target audience. For example, the input may define the mobile application feature by indicating that the target audience has installed both Yahoo! Finance and Yahoo! News mobile applications. The input may define a technology feature by indicating that the target audience should have a smartphone with an NFC chip or other types of specific hardware components. The input may define a publisher feature by indicating that the target audience should have at least one interaction with a particular publisher using his or her smartphone.

The results field 720 may display the selected audience segments at least partially based on the dot products described above. The advertiser may further manually remove or adjust the final audience segments by removing one or more displayed audience segment through the results field 720.

The field 730 may display a checkbox for the advertiser to select whether the advertiser would let the computer system to automatically optimize the audience segments based on advertiser inputs.

The projection 740 may display performance estimates including information on how fast the budge may be used and how long a predetermined performance goal may be reached if using the presented audience segments displayed in results 720. The performance estimates may be updated in real time when the advertiser manually adjust the final audience segments.

The disclosed computer implemented method may be stored in computer-readable storage medium. The computer-readable storage medium is accessible to at least one hardware processor. The processor is configured to implement the stored instructions to index audience segments by keywords, so that the audience segments are searchable by keywords.

From the foregoing, it can be seen that the present embodiments provide a computer system that creates keyword index for audience segments which has both semantic and performance meanings. The computer system provides an intuitive user interface to allow advertiser to use keyword to search for any audience segments. The computer system uses an offline process to build keyword index for each audience segment, where the keyword index gives both semantics and performance meaning to such keywords for a segment. The computer system uses an online process to get segment search results in real time from audience search user interface.

The solution is more general and not limited to specific marketplaces, as long as there is audience search function by keywords. Further, the systems and methods cover broader concepts of audience including multiple features comparing to narrowly defined behavior targeting user signal segments. The methods provide a unified solution for both segments built by Yahoo! and segments built by third parties, independent of underlying data sources. The computer system identifies the matched audience segment that has best expected performance for campaign related to the input from an advertiser.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising:
a processor and a non-transitory storage medium accessible to the processor;
a memory storing a database comprising segment data and campaign data;
a computer server in communication with the memory and the database, the computer server programmed to:
obtain a performance-lift vector for an audience segment, the performance-lift vector comprising a difference of a performance of the audience segment for a campaign and an average performance of other audience segments for the campaign;
obtain a campaign vector using meta-data from the campaign data;
obtain a keyword vector for the audience segment using the performance-lift vector and the campaign vector;
receive an input from a user interface accessible to an advertiser; and
search the segment data at least partially based on the input and the keyword vector for segments in the segment data.

2. The system of claim 1, wherein the database comprises segment data comprising: search data, social data, content data, and email data.

3. The system of claim 1, wherein the audience segment comprises a plurality of audience features comprising at least one of: a geographical feature of the audience segment, a demographical feature of the audience segment, a mobile application related to the audience segment, a technology related to the audience segment, and a publisher related to the audience segment.

4. The system of claim 3, wherein the user interface comprises a plurality user input fields at least partially related to the plurality of audience features.

5. The system of claim 1, wherein the computer server is programmed to obtain and update the performance-lift vector, the campaign vector, and the keyword vector periodically in an offline training process.

6. The system of claim 1,
wherein the computer server is programmed to obtain an input vector using the input, the input vector indicating at least one of: a geographical feature, a demographical feature, a mobile application feature, a technology feature, and a publisher feature; and
wherein the computer server is programmed to select and recommend an audience segment to the advertiser using a dot product of the input vector and the keyword vector.

7. The system of claim 1, wherein the campaign vector comprises a sub-vector of keywords and a sub-vector of weighs corresponding to the sub-vector of keywords, and the sub-vector of keywords comprises keywords at least partially related to creative landing uniform resource locator (URL), advertiser name, and product name.

8. The system of claim 7, wherein the computer server is programmed to obtain the sub-vector of weighs corresponding to the sub-vector of keywords using a process based on a term frequency-inverse document frequency (TF-IDF) of the keywords in the sub-vector of keywords.

9. A method, comprising:
obtaining, by one or more devices having a processor, segment data and campaign data from a memory storing a database;
obtaining, by the one or more devices, a performance-lift vector for an audience segment, the performance-lift vector comprising a difference of a performance of the audience segment for a campaign and an average performance of other audience segments for the campaign;
obtaining, by the one or more devices, a campaign vector using meta-data from the campaign data;
obtaining, by the one or more devices, a keyword vector for the audience segment using the performance-lift vector and the campaign vector; and
searching, by the one or more devices, the segment data at least partially based on an input and the keyword vector for segments in the segment data.

10. The method of claim 9, further comprising:
receiving the input from a user interface accessible to an advertiser.

11. The method of claim 10, wherein the audience segment comprises a plurality of audience features comprising at least one of: a geographical feature of the audience segment, a demographical feature of the audience segment, a mobile application related to the audience segment, a technology related to the audience segment, and a publisher related to the audience segment.

12. The method of claim 11, wherein the user interface comprises a plurality user input fields at least partially related to the plurality of audience features.

13. The method of claim 9, further comprising:
obtaining and updating the performance-lift vector, the campaign vector, and the keyword vector periodically in an offline training process.

14. The method of claim 9, further comprising:
obtaining an input vector using the input, the input vector indicating at least one of: a geographical feature, a demographical feature, a mobile application feature, a technology feature, and a publisher feature;
selecting an audience segment using a dot product of an input vector and the keyword vector; and
displaying the selected audience segment in a user interface accessible to an advertiser.

15. The method of claim 9, wherein the campaign vector comprises a sub-vector of keywords and a sub-vector of weighs corresponding to the sub-vector of keywords, and the sub-vector of keywords comprises keywords at least partially related to creative landing uniform resource locator (URL), advertiser name, and product name.

16. The method of claim 15, further comprising:
obtaining the sub-vector of weighs corresponding to the sub-vector of keywords using a process based on a term frequency-inverse document frequency (TF-IDF) of the keywords in the sub-vector of keywords.

17. A non-transitory storage medium configured to store modules comprising:
module for obtaining a performance-lift vector for an audience segment, the performance-lift vector comprising a difference of a performance of the audience segment for a campaign and an average performance of other audience segments for the campaign;
module for obtaining a campaign vector using meta-data from a database comprising campaign data;
module for obtaining a keyword vector for the audience segment using the performance-lift vector and the campaign vector;
module for displaying a user interface and receiving an input from the user interface accessible to an advertiser; and
module for searching a database comprising segment data at least partially based on an input and the keyword vector for segments in the segment data.

18. The non-transitory storage medium of claim 17, wherein the modules further comprise:
module for obtaining and updating the performance-lift vector, the campaign vector, and the keyword vector periodically in an offline training process;
module for selecting an audience segment using a dot product of an input vector and the keyword vector, the input vector at least partially related to the input; and
module for displaying the selected audience segment in the user interface.

19. The non-transitory storage medium of claim 17,
wherein the audience segment comprises a plurality of audience features comprising at least one of: a geographical feature of the audience segment, a demographical feature of the audience segment, a mobile application related to the audience segment, a technology related to the audience segment, and a publisher related to the audience segment; and
wherein the user interface comprises a plurality user input fields at least partially related to the plurality of audience features.

20. The non-transitory storage medium of claim 17, wherein the campaign vector comprises a sub-vector of keywords and a sub-vector of weighs corresponding to the sub-vector of keywords, and the sub-vector of keywords comprises keywords at least partially related to creative landing uniform resource locator (URL), advertiser name, and product name.

21. A system for identifying an audience, the system comprising:
a backend computer server in communication with a database, the backend computer server programmed to: obtain a performance-lift vector for an audience segment, obtain a keyword vector for the audience segment at least partially based on the performance-lift vector, and save the keyword vector in the database; and
a frontend computer server in communication with the database, the frontend computer server programmed to: receive an input from a user interface and search the database at least partially based on the input and the keyword vector.

22. The system of claim 21, wherein the performance-lift vector comprises a difference of a performance of the audience segment for a campaign and an average performance of other audience segments for the campaign.

23. The system of claim 21, wherein the audience segment comprises a plurality of audience features comprising at least one of: a geographical feature of the audience segment, a demographical feature of the audience segment, a mobile application related to the audience segment, a technology related to the audience segment, and a publisher related to the audience segment.

24. The system of claim 21, wherein the keyword vector comprises: a plurality of campaign topics indicating semantics relevance and corresponding weights indicating performances of the plurality of campaign topics.

25. The system of claim 21, wherein the frontend computer server is programmed to:
obtain an input vector using the input, the input vector indicating at least one of: a geographical feature, a demographical feature, a mobile application feature, a technology feature, and a publisher feature;
select an audience segment using a dot product of the input vector and the keyword vector in real time; and
display information indicating the selected audience to an advertiser.

26. The system of claim 21, wherein the backend computer server is programmed to obtain a campaign vector that comprises a sub-vector of keywords and a sub-vector of weighs corresponding to the sub-vector of keywords, and the sub-vector of keywords comprises keywords at least partially related to creative landing uniform resource locator (URL), advertiser name, and product name.

27. The system of claim 26, wherein the backend computer server is programmed to obtain and update the performance-lift vector, the campaign vector, and the keyword vector periodically in an offline training process.

28. The system of claim 27, wherein the backend computer server is programmed to obtain the sub-vector of weighs corresponding to the sub-vector of keywords using a process based on a term frequency-inverse document frequency (TF-IDF) of the keywords in the sub-vector of keywords.
